(19) United States
(12) Patent Application Publication
(10) Pub. No.: US 2008/0156654 A1
(43) Pub. Date: Jul. 3, 2008

(54) Identification Based On Compositionally Encoded Nanostructures

(76) Inventors: Joseph Wang, Scottsdale, AZ (US); Guodong Liu, Richland, WA (US)

Correspondence Address: FISH & RICHARDSON, PC, P.O. BOX 1022, MINNEAPOLIS, MN, 55440-1022, US

(21) Appl. No.: 11/836,079

(22) Filed: Aug. 8, 2007

Related U.S. Application Data
(60) Provisional application No. 60/836,268, filed on Aug. 8, 2006.

(51) Int. Cl. C25D 3/56; C25D 3/58; G01N 27/26

(52) U.S. Cl. 205/239; 205/238; 205/790; 205/255; 205/244

(57) ABSTRACT

Designs, fabrication and applications of nanostructures made of an alloy of two or more different metal elements to provide a unique identification code based on the composition of the alloy. Such compositionally encoded nanostructures can be in various geometries including but not limited to nanoparticles, nanowires and nanotubes. In one example, a single-step electroplating process may be used to form alloy nanowires without separate electroplating steps.

### PRIORITY CLAIM

This application claims the priority of U.S. Provisional Application No. 60/836,268 entitled “Bar-Coded Alloy Nanowires” and filed on Aug. 8, 2006, which is incorporated by reference as part of the specification of this application.

### FEDERAL FUNDING

The invention described herein was made with government funding from the National Science Foundation under Grant No. CHE 0506529, from the National Institutes of Health under Grant No. R01 EP002189, and from the Star Program at the Environmental Protection Agency under Grant No. 83090002. The United States Government may have certain rights in the invention.

### BACKGROUND

This application relates to nanostructures such as nanowires, nanorods, nanoparticles and other nano-scale structures.

Microstructures with a scale on the order of one micron or less along at least one dimension of the microstructures are nanostructures. Nanostructures can be in various geometries and dimensions and may be referred to as nanowires, nanorods, or nanoparticles. Elongated nanostructures with a width on the order of one micron or less and a length ranging from hundreds of microns to microns or tens of microns can be designed to have different lengthwise segments made of two or more different materials as encoded nanoparticles or nanowires for identifying objects in various applications such as product recognition, anti-counterfeiting, and bio-tagging. The difference in one or more properties of different segments made of different materials can be detected and used to provide unique encoding codes for identification and authentication. Examples of segmented nanoparticles or nanowires can be found in various literature, e.g., International Patent Application WO2005/020890A2 by Penn et al., U.S. patent Applications US2006/0038979A1 and US2005/0032226A1 by Natan et al., U.S. patent Application No. US2005/0019556A1 by Freeman et al., and an article entitled “Encoded beads for electrochemical identification” by Wang et al. in Anal. Chem. Vol. 75, page 4667-4671 (2003). In these and other multi-segment nanoparticle or nanowire tags, the different segments made of different materials are usually manufactured by electroplating different metal materials in pores of a porous membrane via multiple electroplating steps. The readout of such multi-segment nanoparticle or nanowire tags can be achieved by optical reflectivity microscopy or electrochemical stripping voltammetry.

Such encoded nanoparticles or nanowires provide an alternative to conventional tagging techniques such as printed barcodes or RFID tags and may be used to provide various advantages over other tagging techniques such as large coding capacity and low manufacturing cost.

### SUMMARY

The specification of this application describes, among others, designs, fabrication and applications of nanoparticles or nanowires made of an alloy of two or more different metal elements to provide a unique identification code the composition of the alloy. A single-step electroplating process may be used to form the alloy nanowires without separate electroplating steps.

In one aspect, an article is disclosed to provide an identification tag which comprises alloy nanostructures of an alloy of two or more different metal elements. A combination of (1) a number of the two or more different metal elements and (2) relative concentrations of the two or more different metal elements constitutes a unique identification code for the identification tag. The alloy can be formed from, for example, a single electroplating process using a plating solution comprising a mixture of the two or more different metal elements.

In another aspect, a method for synthesizing a nanostructure identification tag is described to include performing a single deposition step to deposit two or more different metal elements on a template to grow alloy nanostructure of an alloy of the two or more different metal elements; and using the alloy nanostructures removed from the template to form a nanostructure identification tag for identification based on the relative concentrations of the two or more different metal elements in the alloy.

In yet another aspect, a method for synthesizing a nanostructure identification tag is disclosed to include performing a single electroplating step by using a plating solution comprising a mixture of two or more different metal elements to electroplate the two or more different metal elements on a membrane having pores to grow alloy nanowires of an alloy of the two or more different metal elements in the pores; and using the alloy nanowires removed from the membrane to form a nanostructure identification tag for identification based on the relative concentrations of the two or more different metal elements in the alloy.

In yet another aspect, a method for providing a nanostructure identification tag is disclosed to include stimulating an identification tag comprising alloy nanostructures to produce a signal. Each of the alloy nanostructures is made of an alloy of two or more different metal elements with predetermined relative concentrations of the two or more different metal elements in the alloy. The method includes measuring the signal from the alloy nanostructures to extract information on the predetermined relative concentrations of the two or more different metal elements in the alloy; and using a combination of (1) the predetermined relative concentrations of the two or more metal elements, and (2) a number of the two or more metal elements as an identification code to identify an object associated with the identification tag.

These and other examples and implementations are described in detail in the drawings, the detailed description and the claims.

### BRIEF DESCRIPTION OF THE DRAWINGS

FIG. 1A shows an example of a nanostructure identification tag system with a nanostructure identification tag having compositionally encoded alloy nanowires and a tag reader instrument for reading the tag.

FIG. 1B illustrates the compositionally encoded alloy nanowires of a single alloy of two or more selected metal elements in the tag in FIG. 1A.

FIG. 1C illustrates a Scanning electron microscopy (SEM) image of compositionally encoded alloy nanowires made of equal amounts of In, Pb and Bi with a diameter of about 200 nm.

FIG. 2 illustrates one exemplary process for synthesizing compositionally encoded alloy nanowires based on a single-step electroplating process.

FIG. 3 is a schematic illustration of the template-guided electrochemical synthesis of alloy nanowires electronic tags where the SEM image shows alloy nanowires prepared from a plating solution with a predetermined concentration ratio of 1.0 In/1.0 Pb/1.0 Bi.

FIG. 4 shows measured Square-wave stripping voltammograms of dissolved metal alloy nanowires of different In—Pb—Bi alloy nanowires samples.

FIG. 5 shows measured square-wave stripping voltammograms of dissolved alloy nanowires prepared with different deposition times: 10 min (A), 20 min (B), 30 min (C), 40 min (D) and 60 min (E) that correspond to lengths of 0.5-3.0 μm), where the predetermined concentration ratio in the plating solution is a mixture of 5.0 In/5.0Pb/5.0Bi and other conditions are the same as the measurements shown in FIG. 4.

FIG. 6 shows measured square-wave voltammograms of dissolved alloy nanowires (1.0 In/1.0Pb/1.0Bi) prepared by the one-step (A) and multi-step (B) deposition schemes.

FIG. 7 shows histograms for voltammetric measurements to show reproducibility of the alloy-nanowire voltammetric signatures using six different nanowire suspensions. The inset shows stripping voltammograms of the individual nanowire suspensions. A predetermined concentration ratio in the plating solution of 4.0 In/1.0Pb/4.0 Bi. Other conditions are the same as the measurements shown in FIG. 4.

FIG. 8 shows an example of non-destructive XRF readout of barcoded alloy nanowires for product tracking and authenticity testing.

FIG. 9 shows measurements of X-ray fluorescence of multi-metal alloy nanowires prepared by changing the concentration of one of the metals (Co (A), Ni (B) and Cu (C)) while keeping the level of others constant.

FIG. 10 shows measurements of XRF readout of Co—Ni—Cu alloy nanowires of different lengths, prepared by using different plating charges: 2 C (a), 5 C (b), 10 C (C), and 15 C (d) and a plating solution containing 5 g L⁻¹ of the corresponding metal salts. Other conditions are as in FIG. 2.

FIG. 11 shows a comparison of the alloy-nanowire XRF signatures obtained in various experiments. (A) XRF spectra obtained using (i) the laboratory-based (Kevex XRF) instrument and (ii) a compact handheld XRF analyzer (NITON). The nanowires were prepared using a plating solution containing 30 g L⁻¹, 45 g L⁻¹, and 10 g L⁻¹ of the Co, Ni and Cu salts. (B) XRF spectra of (i) nanowires embedded in the alumina membrane and of (ii) the nanowires in solution (after the membrane dissolution). The nanowires were prepared using a plating solution containing 30 g L⁻¹, 120 g L⁻¹, and 10 g L⁻¹ of the Co, Ni and Cu salts

FIG. 12 shows measured XRF signatures of alloy nanowires incorporated within inks or plastics. (A) Nanowire XRF signatures recorded with the nanowires (i) embedded in the membrane template or (ii) dispersed within an ink dispensed on a white printing paper. The nanowires were prepared using a plating solution containing 30 g L⁻¹, 50 g L⁻¹, and 10 g L⁻¹ of the Co, Ni and Cu salts. (B) Nanowire XRF signatures for (i) nanowires embedded in the membrane template or (ii) nanowires embedded between fused plastic (COC) sheets. The nanowires were prepared using a plating solution containing 30 g L⁻¹, 90 g L⁻¹, and 10 g L⁻¹ of the Co, Ni and Cu salts.

FIGS. 13A and 13B show examples of multi-segment nanostructures that include one segment made of a compositionally encoded alloy nanostructure for identification or authentication and one or more segments to provide additional functions.

FIGS. 14A, 14B and 14C show specific examples of multi-segment nanostructures based on the designs in FIGS. 13A and 13B.

### DETAILED DESCRIPTION

Examples and implementations of nanostructures in this application use a single segment of an alloy of two or more different metal elements to provide a unique identification code based on the composition of the alloy. The code can be, for example, a combination of (1) the number of the two or more different metal elements in the alloy and (2) relative concentrations of the two or more different metal elements in the alloy. The two or more different metal elements are not spatially separated into different segments and are spatially mixed in form of the alloy within the same segment. The encoding for the identification code is based on the composition of the alloy and is not based on any spatial difference caused by different segments. Therefore, nanostructures in this application are compositionally encoded in a single segment of the alloy. The encoding capacity of such alloy nanostructures is sufficiently large for many applications and the total number of different codes is n^{m}−1, where n is the number of the two or more different metal elements in the alloy and m is the number of detectable different relative concentrations in each of the two or more different metal elements in the alloy. Hence, thousands of encoding patterns can be achieved by using five or six different metals in the alloy with four or five different relative concentrations of the metals in the alloy.

Various geometries and dimensions may be used for the compositionally encoded alloy nanostructures described in this application. The shape of such a compositionally encoded alloy nanostructure may be elongated to have a dimension along one direction greater than another direction (e.g. a wire-like structures, tubes, ellipsoids), may have similarly sizes in different directions (e.g., spheres or cubes), or in other shapes such as stars. Depending on the geometry, a compositionally encoded alloy nanostructure may be referred to as a nanoparticle, nanowire or other term to signify the geometry. For an elongated wire or tube structure, the cross section can be in various shapes: circular, elliptical, square, rectangular, polygonal, star, and others. Specific examples described in this application are compositionally encoded nanowires and are provided to illustrate various features of compositionally encoded nanostructures that may be implemented in geometries different from nanowires. One reason that different geometries can be used in compositionally encoded alloy nanostructures is that the encoding and the readout of the code are based on the composition and are independent of the geometry or shape of the nanostructure. Notably, such a compositionally encoded alloy nanostructure is a uniform composition of an alloy of selected two or more metal elements throughout the nanostructure and does not have distinctive segments made of different metal materials.

Metals that can be alloyed with one another may be selected from a range of metal elements to construct compositionally encoded nanostructures based on the examples and implementations described in this application. For example, the two or more metals for a compositionally encoded alloy nanostructure can be selected based on the readout technique.

For voltammetry readout, the metals should be selected to have distinguishable voltammetric signature signals. For an optical readout based on the optical spectral properties of the metal elements, the metals should be selected to have distinguishable optical spectral signals. The X-ray fluorescence (XRF) detection is an example of the optical readout and the metals should be selected to have distinguishable XRF peaks. Metals that can be electroplated or alloyed to form a desired alloy for a compositionally encoded alloy can be used. Examples of suitable metals for compositionally encoded alloy nanostructures in some applications include but are not limited to Bi, Sb, Pb, Sn, Tl, In, Ga, Cd, Zn, Au, Ag, Cu, Ni, Co, Te and Se. In addition to readout considerations, other considerations may also be included in selection of the two or more metals for a compositionally encoded alloy. For example, the magnetic property of the compositionally encoded alloy, such as a Co—Ni—Cu alloy, may be considered to facilitate magnetic separation of the compositionally encoded nanostructures (e.g., nanowires) during the fabrication process. For another example, the alloy composition may be selected to allow for attachment to another structure such as a molecule or a metal.

The readout of such a compositionally encoded tag can include stimulating or exciting an identification tag containing compositionally encoded alloy nanostructures to produce a signal, measuring the signal from the alloy nanostructures to extract information on the predetermined relative concentrations of the alloy; and using a combination of (1) the predetermined relative concentrations of the two or more metal elements, and (2) a number of the two or more metal elements as an identification code to identify an object associated with the identification tag. As a specific example, an X-ray fluorescence (XRF) readout uses X-ray to stimulate the identification tag containing compositionally encoded alloy nanostructures and the XRF signal produced by the compositionally encoded alloy nanostructures under the X-ray excitation is measured to read the code. In a voltammetry readout, the identification tag containing compositionally encoded alloy nanostructures is dissolved in a solution and an electrical voltage is applied through the solution to electrochemically stimulate and read the encoded alloy nanostructures. The readout of compositionally encoded alloy nanostructures can be implemented based on various material characterization technologies including but not limited to optical readout technologies and electrochemical readout technologies. Some readout examples are Energy Dispersive X-Ray Microanalysis/Spectroscopy, Electron Backscatter Diffraction detection, Micro X-Ray Fluorescence Detection, Raman Fluorescence Spectroscopy, Raman Flame Spectroscopy, Inductively Coupled Plasma Mass Spectrometry Detection, Linear Sweep Voltammetry detection, Pulse Voltammetry detection, Square Wave Voltammetry detection, and solid-state chronopotentiometric measurement. A readout technology for a compositionally encoded tag can be a destructive readout where the tag is destroyed and can be read once. A voltammetry readout is a destructive readout in which the tag is dissolved in a solution in order to conduct voltammetric measurements. A readout technology for a compositionally encoded tag can also be a non-destructive readout where the compositionally encoded tag is preserved after each readout and can be read multiple times. The XRF readout and the solid-state chronopotentiometric readout are two examples for a non-destructive readout.

Compositionally encoded alloy nanostructures based on the examples and implementations described in this application can be fabricated by various techniques. Electroplating and various multi-component deposition processes such as a multi-component vapor deposition like sputtering may be used to fabricate the alloy nanostructures. A template can be designed to include multiple nano-scale structures shaped to grow desired alloy nanostructures and the selected materials for the alloy are deposited into the nano-scale structures of the template to form the alloy nanostructures. The nano-scale structure is shaped based on the geometry of the desired nanostructure. For nanowires, the template can be a membrane with nano pores whose internal geometry defines the shape of the nanowires. Selected materials for the alloy are deposited into the nano pores to form the nanowires.

Notably, a single-step alloying process based on electroplating or another multi-component deposition process can be used to fabricate compositionally encoded alloy nanostructures to simplify the fabrication process, improve fabrication accuracy and reduce the fabrication cost. Such a single-step process can be advantageous over multi-step processes. For example, segmented, bar-coded nanoparticle or nanowire tags with multiple segments are often fabricated by a multi-step electroplating process in which multiple time-consuming electroplating steps are performed sequentially to form the different segments with different plating solutions for plating different metals. Such a multi-step electroplating process requires careful chemical and layer process control for dimensional accuracy and repeatability. The replacement of metal plating solutions between different electroplating steps in these multi-step processes can further complicate the control, accuracy and repeatability of the processes. Fabrication of segmentless, compositionally encoded alloy nanostructures described in this application can use a single electroplating process to avoid the multiple electroplating steps and thus avoid various limitations and problems associated with multi-step electroplating processes. The examples provided below illustrate a single-step template-guided electrodeposition process to prepare nanowire tags from a solution containing different concentrations of metal ions. The specific ratio of these metal alloys deposited from solution provides a unique signature for the resulting nanowire tags. The ratio of metal alloys and the resulting nanowire tag composition may be varied to produce numerous encoded signatures which may be detected and distinguished using various readout methods.

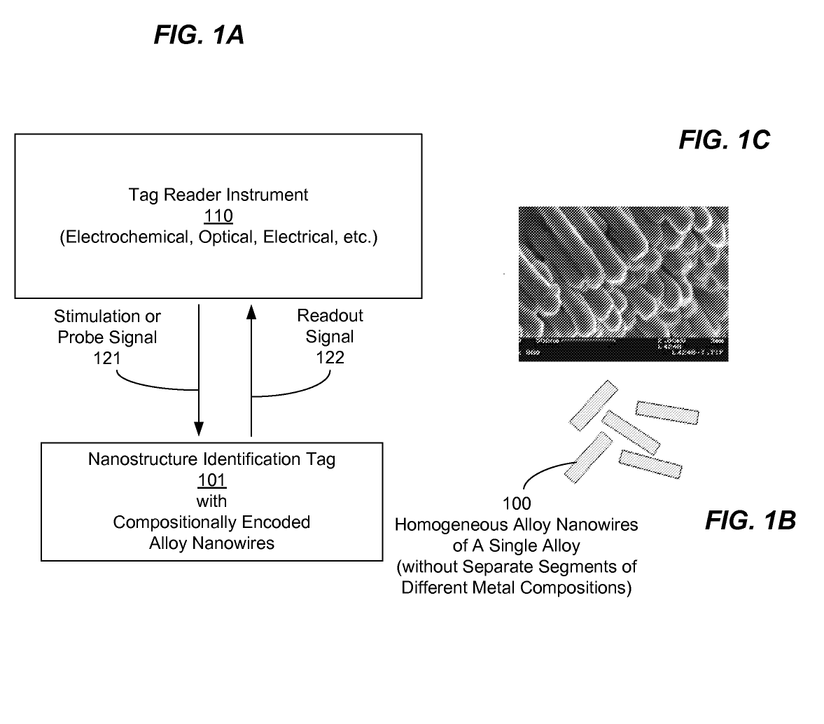

FIG. 1A shows an example of a nanostructure identification tag system with a nanostructure identification tag 101 having compositionally encoded alloy nanowires 100 and a tag reader instrument 110 for reading the tag. The tag reader instrument 110 is operated to apply a simulation or probe signal 121 to the tag 101 to interact with the compositionally encoded alloy nanowires 100. This interaction produces a readout signal 122 that is received and read by the tag reader instrument 110. The readout signal 122 is processed to extract the compositionally encoded code of the tag 101. The readout can be destructive where the readout process destroys the tag 101 or non-destructive where the tag 101 is preserved and can be read out again.

FIG. 1B illustrates the compositionally encoded alloy nanowires 100 of a single alloy of two or more selected metal elements in the tag 101 in FIG. 1A. FIG. 1C illustrates a Scanning electron microscopy (SEM) image of compositionally encoded alloy nanowires made of equal amounts of In, Pb and Bi with a diameter of about 200 nm formed by a single-step template-guided electrodeposition process from solutions containing different concentrations of metal ions In, Pb and Bi. The distinct encoding of the nanowire tags is obtained through the specific ratio of metal alloys deposited from solution rather than through the multiple discrete metal layers required in sequentially electroplated striped nanowires. The alloy nanowire preparation method leads to a high coding capacity with a large number of distinguishable signatures or identities, determined by the composition of the metal mixture plating solution and the resulting nanowire composition. The single-step alloy deposition process is simpler and faster than the process of segmented nanowire preparation and eliminates the need for narrow nanowire length tolerances and metal layer control. The nanowires preparation is not limited to electrodeposition, and other deposition processes may be used to form a single metal alloy nanowire.

The tag 101 in FIG. 1A can be in various configurations based on applications. For example, the nanowires 100 may be embedded within a polymer or plastic material to form the tag 101. For another example, the nanowires 100 may be embedded in an ink and the ink is then printed on a surface as the tag 101. For yet another example, the nanowires 100 may be functionalized to attach to a molecule structure or a nanostructure which is attached to a surface.

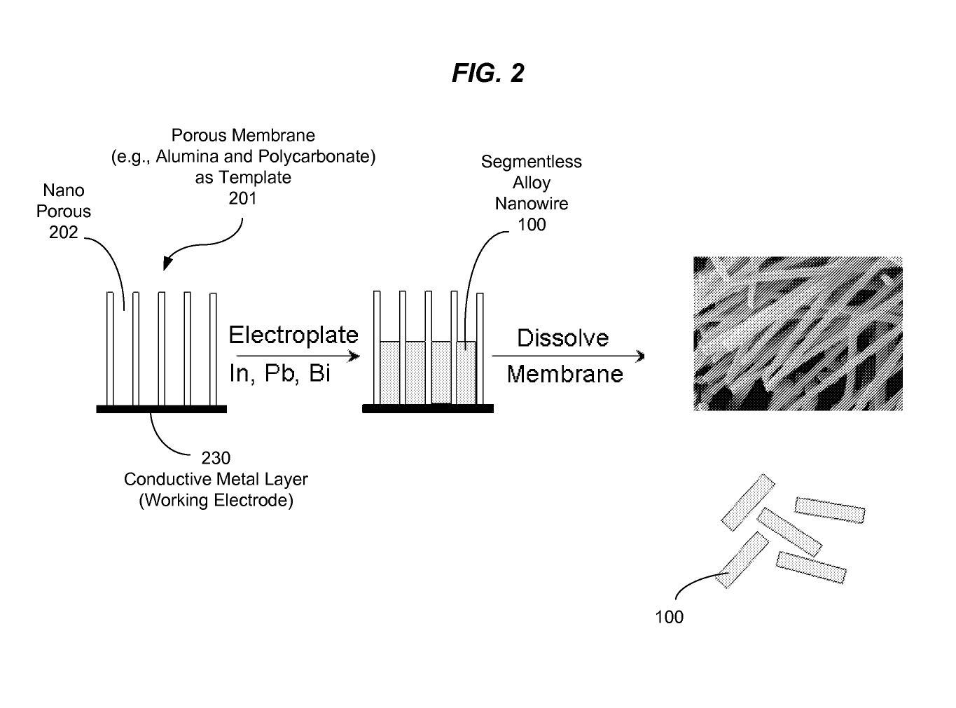

FIG. 2 illustrates one exemplary process for synthesizing compositionally encoded alloy nanowires based on a single-step electroplating process. A porous membrane 201 is provided as the template and the membrane 201 has nano-scale pores 202 in the substrate as nano-scale molding templates in which alloy nanowires are grown via electroplating. The size of the pores 202 can vary based on the size of the cross section of alloy nanowires to be formed. Porous alumina or polycarbonate membranes, for example, may be used. A conductive metal layer 230 is deposited on one side of the porous membrane 201 to seal the pores 201 on the deposited side and is later used as the working electrode for the electroplating process. Next, a single-step electroplating process is performed to electroplate metal ions (e.g., In, Pb and Bi as illustrated) in a plating solution on the unsealed porous side of the porous membrane 201. The alloy of the metal ions is formed in the pores 202 via electroplating to form the alloy nanowires 100. During the electroplating, the conductive metal layer 230 may be isolated from being in contact with the plating solution. After a desired length of the alloy nanowires 100 is achieved, the electroplating process is terminated. Next, the membrane 201 with the alloy nanowires are dissolved to obtain the alloy nanowires 100.

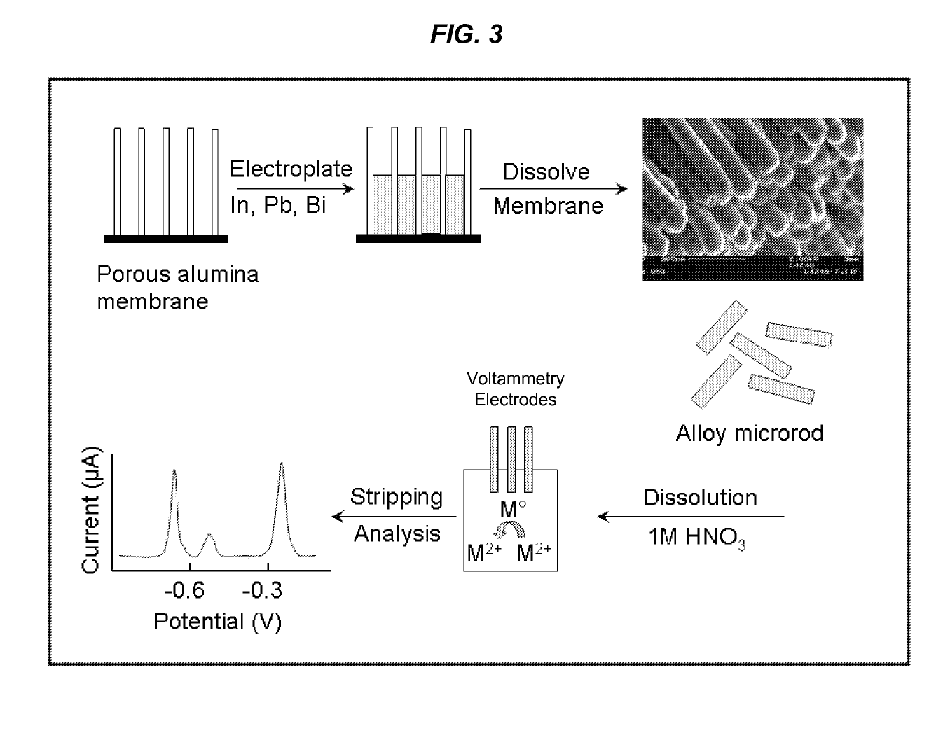

FIG. 3 illustrates an example for fabricating In—Pb—Bi alloy nanowires from a porous alumina membrane and the voltammetric readout of the code in the In—Pb—Bi alloy nanowires via square-wave voltammetry (SWV) stripping measurements of current-voltage curves (voltammograms) obtained by applying voltages through an electrically conductive solution in which the In—Pb—Bi alloy nanowires are dissolved. This example demonstrates how multimetal nanowire tags can be prepared using a single template-guided electrodeposition. Unlike optical reflectivity reading of nanowire striping patterns, the multipotential/current intensities voltammetric signatures of electronic nanowire tags reflect the identify and level of the corresponding metal constituents and, hence, can be obtained by a single-step electrodeposition of alloy nanowires from plating solutions containing different levels of various metal ions. Such one-step preparation of allow nanowires with different compositions patterns offers a similar number of possible combinations as the sequential electrodeposition route, with n^{m}−1 possible voltammetric fingerprints, where m is the potential (corresponding to the metal marker) and n is the current intensity (reflecting its original concentration). It is thus possible to achieve thousands of bar code patterns in connection to five or six different potentials and four or five different current intensities. Such high coding capacity and identification accuracy are coupled to a greatly simplified and fast preparation scheme compared to sequentially electroplated striped nanowires. The encoded nanowires do not have separate segments to provide bar code patterns and the compositions of the alloy of the nanowires provide segmentless “built-in” coding in the same (alloy) material. This aspect is different from bar codes based on spatially resolved wire segments or mixing different dyes or quantum dots.

Apparatus and chemical regents used in the example in FIG. 3 are as follows. Electroplating was accomplished us a CHI440 analyzer that was controlled by CHI 2.06 software (CH Instruments, Austin, Tex.). All centrifugation steps were performed using a Micromax centrifuge (Thermo IEC, MA). The sliver film (on the alumina membrane) was prepared by laser ablation of solid silver target in connection with a YAG laser (Quanta-Ray CDR-02A, Mountain View, Calif.). Square-wave voltammetric (SWV) stripping measurements were performed with a μAutolab Type II system (Eco Chemie, The Netherlands), using a 1.5-mL glass electrochemical cell, containing the mercury-coated glassy carbon disk electrode (2-mm diameter), a Ag/AgCl reference electrode, and a platinum counter electrode. Scanning electron microscopy (SEM) images were obtained with a Jeol JSM-5900 LV microscope, using an accelerating voltage of 10 kV. All stock solutions were prepared using deionized and autoclaved water. The sodium acetate buffer (3 M, pH 5.2), nitric acid, and sodium hydroxide were purchased from Sigma. Silver, bismuth, indium, and lead atomic absorption standard solutions were obtained from Sigma. The mercury atomic absorption standard solution (1010 mg L⁻¹) was purchased from Aldrich. Alumina membranes (25-mm diameter and nominal pore diameter of 200 nm) were purchased from Whatman (Clifton, N.J.).

Alumina membranes with 200-nm pore diameters and annular support rings were used as templates in experiments. Prior to the electroplating, a 0.5-1.0 μm-thick silver layer was thermally evaporated and deposited on one surface of the membrane to provide electrical contact for further electrodeposition. The membrane was placed on a glass slide, with the silver side up. Electrical contact to the membrane was made using an aluminum foil. The aluminum foil acted as a contact to the working electrode, with a platinum wire and Ag/AgCl serving as the counter and reference electrodes, respectively. Silver was then deposited at −5 mA for 20 min [using a 0.2 M acetate buffer solution containing 100 mg L⁻¹ silver(I)] to further seal the membrane and prevent leakage of the plating solution. The membrane was placed on an aluminum foil, which folds the glass slide, so that the silver film on the membrane contacted the foil. A 2-mL acetate buffer solution (0.20 M) containing indium, lead, and bismuth (100 mg L⁻¹ each) was added, and a current of −0.5 mA was applied for 40 min. An electrodeposition efficiency of ˜55% was estimated based on the concentration of the metal ions before and after the plating.

Upon completing the plating, the membrane was rinsed with distilled water and the sliver film backing was dissolved in a 30% HNO₃ solution until the silver color disappeared. The alumina membrane was then rinsed with distilled water and placed in a 3 M NaOH solution for 1 h to dissolve the alumina. The resulting suspension was centrifuged at 8000 rpm to sediment the particles. This process was repeated three times to remove residual salt. The nanowires were dissolved by adding 5 μL of their suspension into 10 μL of a 6 M HNO₃ solution for 40 minutes.

SWV measurements of the dissolved alloy nanowires were performed using a mercury-coated glassy carbon electrode. The glassy carbon surface was first polished with an 0.05-pm alumina slurry and sonicated in 1 M nitric acid, acetone, and deionized water for 5-min periods in each case before the plating. The mercury-coated glassy carbon electrode was prepared in situ following 1-min conditioning at 0.6 V, using a 1-min deposition at −1.1 V, in an acetate buffer (0.20 M, pH 5.2) solution containing 10 mg L⁻¹ mercury and 15 μL of the HNO₃ solution of the dissolved nanowires. Square-wave voltammetric measurements were performed by scanning the potential between −0.9 and 0.0 V, with a step potential of 50 mV, an amplitude of 20 mV, and a frequency of 25 Hz. Baseline correction of the resulting voltammograms was performed using the “moving average mode” of the GPES (Autolab) software.

The example in FIG. 3 demonstrates the ability to generate compositionally encoded nanowire tags with distinct bar code patterns and high identification accuracy using a one-step template-guided electrodeposition from a mixture of metal ions. Alloy nanowires with distinct bar code patterns can thus be prepared by simultaneous reduction of multiple metal ions into the pores of a membrane template. These nanowires are cylindrically shaped with a diameter of about 200 nm and a length ranging from 0.5 to 3.0 μm. The alloy nanowire preparation route leads to a high coding capacity, with a large number of recognizable voltammetric signatures, reflecting the predetermined composition of the metal mixture plating solution. Such use of alloy nanowires to generate distinct bar code patterns is illustrated below with three-metal (In, Pb, Bi) encoded nanowires. The electrochemical readout is time-consuming and destructive. Other nondestructive schemes (discussed below) could provide rapid readout of the easily prepared compositionally encoded alloy nanowires.

The observed voltammetric patterns can be predicted from the composition of the plating solution.

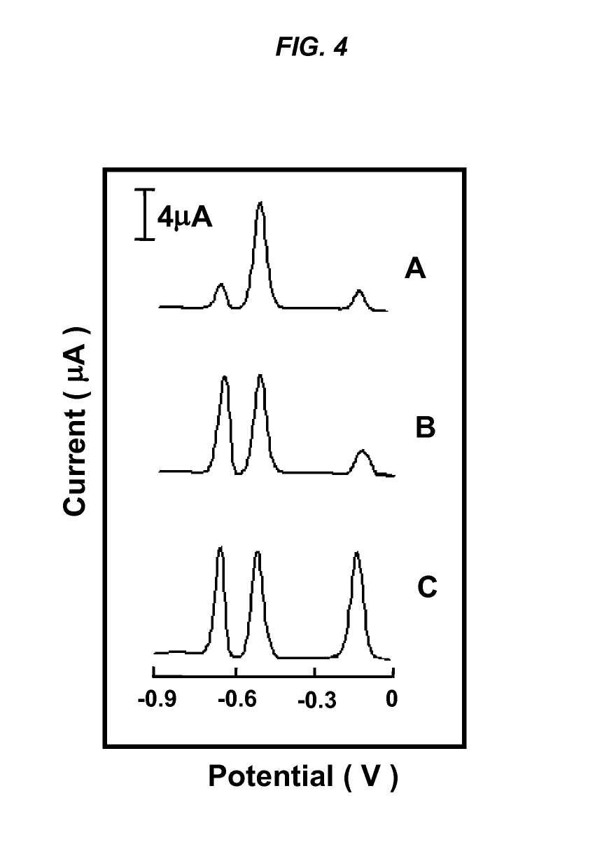

FIG. 4 displays typical voltammograms of dissolved metal alloy nanowire prepared from plating solutions containing different concentration ratios of their indium, lead, and bismuth constituents:In/Pb/Bi ratio of 1:5:1 (A), In/Pb/Bi ratio of 5:5:1 (B), and In/Pb/Bi ratio of 5:5:5 (C). The nanowires were prepared by a 40-min deposition with a constant current −0.5 mA (overall charge of 0.3 C) and different predetermined concentrations in respective plating solutions. Voltammetric stripping readout was obtained with an in-situ plated mercury-coated glassy-carbon electrode, using an one-minute pretreatment at 0.6 V, one-minute accumulation at −1.1 V, a 10-second rest period (without stirring) and a square-wave voltammetric scan. Each nanowire yields a characteristic multipeak voltammogram with sharp, symmetric, and baseline-resolved peaks. The largely different nanowire compositions have no effect upon the peak separation. The peak potentials [−0.66 (IN), −0.52 (Pb), and −0.14 (Bi)V] are independent of the nanowire composition. The ratios of the current intensities [1.0/5.0/0.92 (A), 4.80/5.00/1.06 (B), and 5.10/5.00/5.00 (C) In/Pb/Bi] correlated well with the predetermined concentration of the metal markers in the plating solution.

As expected, the composition of the alloy nanowire and hence the resulting bar code patterns are controlled by the composition of the plating solution. The number of uniquely identifiable nanowires depends on the number of distinguishable (nonoverlapping) metal markers and upon the number of distinguishable current intensities. The number of distinguishable metal markers is controlled by the extent of their peak overlap in the voltammetric scan. The voltammetric stripping reading method commonly allows simultaneous measurements of up to five or six metal markers in a single run (with minimal peak overlap). The number of distinguishable current signals will be determined by the precision of the metal plating process and the precision of the voltammetric measurement (see data below). It is possible to achieve thousands of usable voltammetric signatures with four or five metal markers present at five or six different loadings. Identification algorithms could be used to improve the ability to distinguish between nanowires with very similar composition patterns. The ability to tune the current intensities by controlling the composition of the alloy nanowires, through the composition of the plating solution, is independent of the length of these nanowires. The length of the nanowires is determined by the deposition time and hence the plating charge.

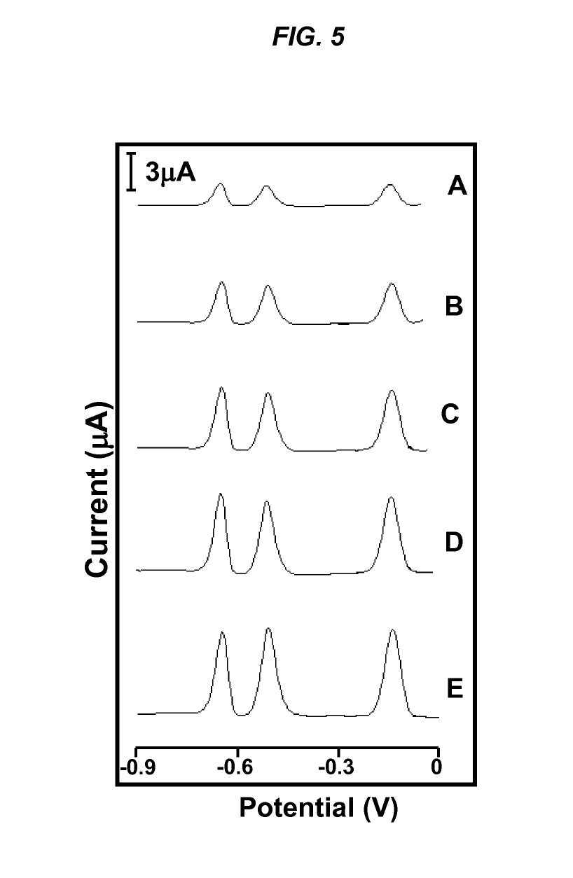

FIG. 5 displays voltammograms for In—Pb—Bi nanowire tags of different lengths ranging from 0.5 to 3.0 μm, prepared with different deposition times ranging from 10(A) to 60 (E) min using a 1:1:1 In/Pb/Bi plating solution. As expected, the current signals increase with the plating time, reflecting the increased length of the resulting nanowires and, hence, the higher amount of the three metal markers. In contrast, the ratio of the peak currents of these metal constituents is nearly independent of the length of the nanowire. In/Pb/Bi current intensities ratios of 1.00/0.91/0.98, 1.00/0.94/0.94, 1.00/0.93/0.96, 1.00/0.94/0.99, and 1.00/1.04/1.04 are observed for the 0.5-, 1.0-, 1.5-, 2.0-, and 3.0-μm-long wires, respectively. In contrast, the length of the nanowire has no affect upon the peak separation. Most subsequent work employed 2-μm-long nanowires, in connection with a 40-min plating time.

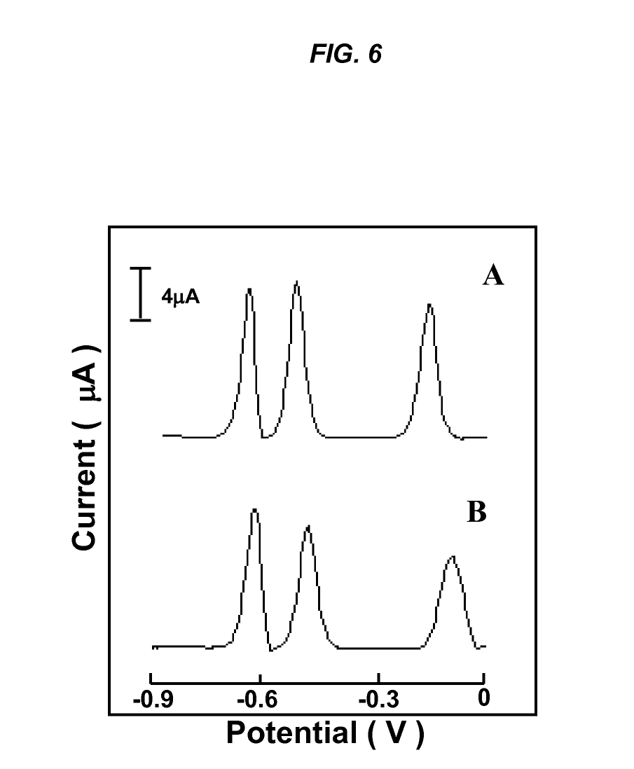

The voltammetric signatures obtained by the one-step alloy preparation route can be compared to voltammetric signatures from the multistep synthesis of multisegment nanowires. FIG. 6 displays stripping voltammograms for segmentless alloy nanowires prepared by the one-step plating process (A) and multisegment nanowires prepared by a multi-step plating process (B). The one-step electrodeposition was performed in a 0.20 M acetate buffer containing indium, lead and bismuth (100 mg L⁻¹ each) with a current of −0.5 mA for 60 minutes. The multi-step electrodeposition was performed sequentially using 100 mg L⁻¹ indium, 100 mg L⁻¹ lead and 100 mg L⁻¹ bismuth solutions with a current of −0.5 mA for 20 minutes for each metal. Other conditions are the same as the measurements shown in FIG. 4. Both protocols result in well-defined voltammograms and resolved indium, lead, and bismuth peaks. The slightly different ratios of the current intensities [0.97_{In}/1.0_{Pb}/0.90_{Bi} (A) vs 1.0_{In}/0.90_{Pb}/0.70_{Bi} (B)]. The current ratio of the one-step preparation scheme correlates better with the ratio of the metal concentration (1.0_{In}/1.0_{Pb}/1.0_{Bi}) in the plating solution(s). Such improved identification accuracy reflects the simplicity of the new one-step protocol, with fewer errors associated with multiple steps and related solution replacements.

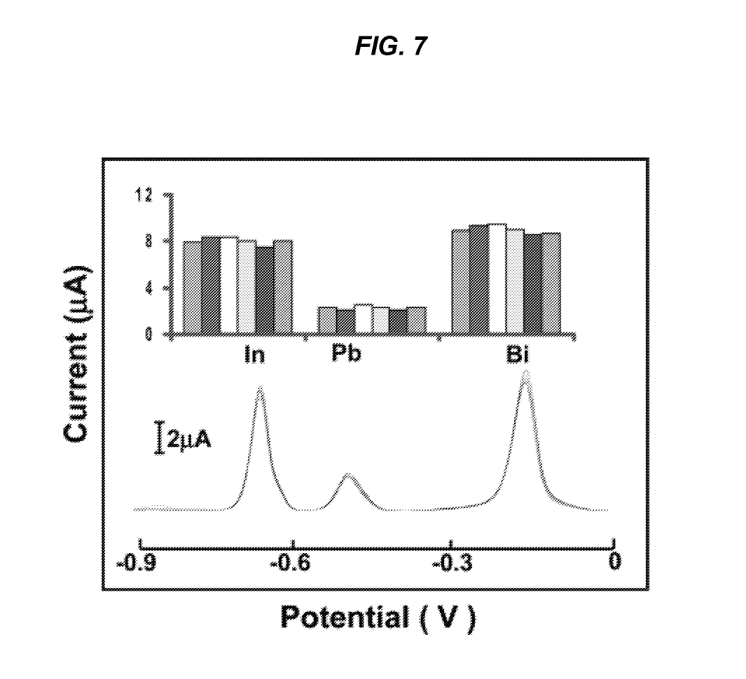

High identification accuracy requires a uniform and reproducible electrodeposition process. The precision and uniformity of the template-directed synthesis of the alloy nanowires were examined by plotting histograms for each current intensity in connection with six different suspensions of the nanowires. The result is shown in FIG. 7. The resulting voltammograms are highly reproducible, reflecting the reproducibility of the plating process and of the electrochemical measurements. Relative standard deviations of 3.8, 6.8, and 3.8% were estimated for the corresponding indium, lead, and bismuth peaks, respectively. The ratio of the mean peak currents (3.8_{In}/1.0_{Pb}/4.1_{Bi}) follows closely their original concentration ration in the plating solution (4.0_{In}/1.0_{Pb}/4.0_{Bi}).

The above measurements demonstrate that compositionally encoded nanowire tags, with a large number of recognizable voltammetric signatures, can be prepared by a single-step electrodeposition from a metal mixture plating solution. Such templated synthesis of alloy nanowire tags with distinct composition patterns is substantially simpler and faster than the preparation of multisegment nanowires (involving sequential plating steps). The resulting voltammetric signatures correlate well with the composition of the metal mixture plating solution, indicating reproducible plating processes. Such bar code patterns are inherent to the alloy composition and do not require combination of different metal segments of nanocrystals. The new protocol thus represents a useful addition to the arsenal of nanomaterial-based identification tags. Further improvements in the speed, identification accuracy, and simplicity of reading the new encoded nanowires could be achieved by eliminating the dissolution step in connection with a nondestructive solid-state chronopotentio-metric measurement or by a direct XOray fluorescence (EDAX element analysis). The latter represents an advantage over optical reading of striped nanowires that commonly requires a CCD-modified optical microscope, along with a proprietary software. The solid-state electrochemical route could be particularly attractive for decentralized applications, in connection with compact (hand-held), battery-powered analyzers.

As a specific example for non-destructive readout of the compositionally encoded alloy nanowires, the following sections describe ternary Co—Ni—Cu alloy nanowires with distinct X-ray fluorescence (XRF) barcode patterns using a one-step template-guided electrodeposition. Such coupling of one-step templated synthesis with a non-destructive XRF readout of the composition patterns greatly simplifies practical applications of barcoded nanomaterials. The example here further illustrates that the compositionally encoded alloy nanowires can provide broad composition ranges and hence lead to a large number of distinguishable XRF signatures. The resulting fluorescence barcodes correlate well with the composition of the metal mixture plating solution, indicating reproducible plating processes. Factors affecting the coding capacity and identification accuracy are examined and potential tracking and authenticity applications involving embedding the nanowires within plastics or inks are demonstrated and discussed.

XRF has been widely used in various fields for rapid and accurate non-destructive metal measurements without sample preparation. The XRF technique can provide both qualitative and quantitative analyses and offers the simultaneous multi-element non-destructive readout of samples over a wide concentration range. XRF has thus been used for detecting the chemical composition of different alloys, ranging from steel to coins and jewelry. Portable (hand-held) XRF analyzers have been particularly useful for on-site non-destructive forensic or archeological analyses¹⁰ in which destructive sampling is not permitted. However, there are no early reports on XRF analyses of barcoded nanowires, in general, and of alloy nanowires, in particular.

Compositionally encoded alloy nanowires can be designed and fabricated with a broad variety of compositions, and hence can be used to provide a large number of unique XRF signatures. The example provided here used a one-step template-guided electrodeposition and a mixture of Ni, Co and Cu ions in an aqueous sulphate plating bath to fabricate the Ni—Co—Cu alloy nanowires. These metals lead to well-resolved and close K-L_{2,3} XRF peaks and hence to a large coding capacity. The resulting XRF barcode patterns reflect the alloy composition and correlate well with the concentration of the different metal ions in the plating solution. Such coupling of one-step templated synthesis of alloy nanowires with a non-destructive XRF readout (without dissolution of the encoded tags) greatly simplifies practical applications of barcoded nanomaterials, making the new strategy extremely attractive for different on-site tagging applications.

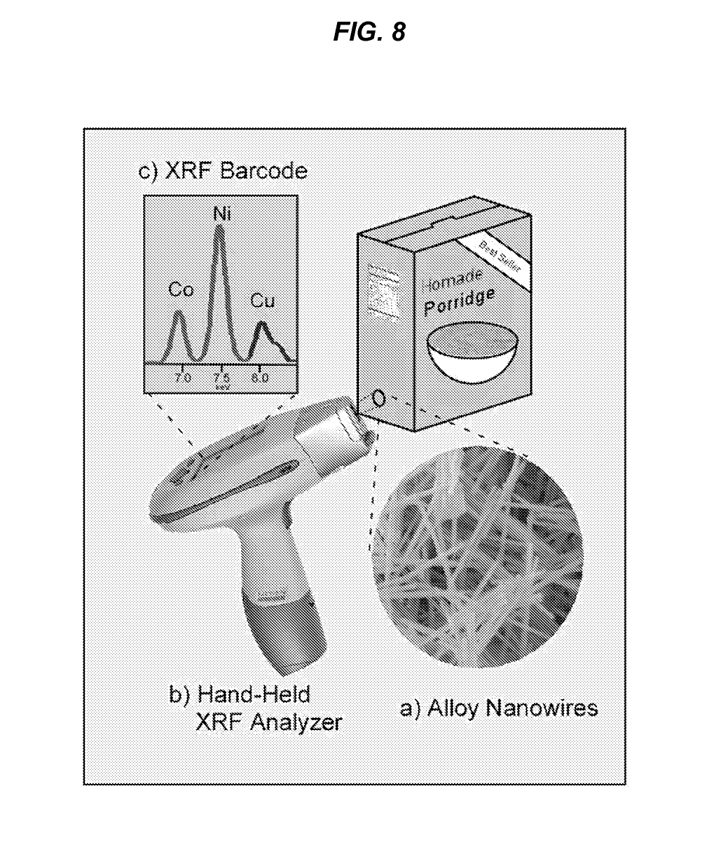

FIG. 8 illustrates a non-destructive XRF readout of barcoded alloy nanowires for product tracking and authenticity testing. Barcoded nanowires are shown in the SEM photomicrograph of inset a) and are dispensed or embedded in a packaging material of a commercial product. A hand-held XRF analyzer (b) is used to read the ID code in the barcoded nanowires The resulting XRF signature (c) is used for the product identification.

The details on various aspects for fabricating the Ni—Co—Cu alloy nanowires are provided below. Sputtering of gold over one side of the alumina membrane was performed with a Denton Vacuum Desk III TSC (Moorestown, N.J.). Electroplating was accomplished using a CHI 440 electrochemical analyzer controlled by CHI 2.06 software (CH Instruments, Austin, Tex.). The sputtered gold was removed from the membrane using a standard 8-inch SEM sample polishing machine (Model 900 Grinder/Polisher, South Bay Technology Inc., VA), along with 3.0 μm alumina powder (Fisher, Pittsburgh, Pa.). Kevex spectrometer model 0810A, (Kevex, Foster City, Calif.) was used for detecting the composition of the encoded alloy nanowires. Hand-held XRF measurements were performed with a NITON XLt 791 Thin Sample Analyzer (Thermo Fisher Scientific, NITON Analyzers, Billerica, Mass.). Scanning electron microscopy (SEM) images were obtained with an XL30 SEM instrument (FEI Co., Hillsboro, Oreg.) using an acceleration potential of 19 kV. The gold target used for sputtering the membrane (99.9+% pure) was purchased from Denton Vacuum (Moorestown, N.J.). The commercial gold and silver plating solutions (Orotemp 24 RTU RACK and 1025 RTU@4.5 Troy/Gallon, respectively) were obtained from Technic Inc. (Anaheim, Calif.). All standard solutions were prepared with ultra-pure (18.2 megaohm) water (ELGA-Ultra-Pure water polishing system model PURELAB ULTRA Scientific). Sodium hydroxide, cupric sulfate pentahydrate (CuSO₄.5H₂O) and nickel sulfate hexahydrate (NiSO₄.6H₂O) were obtained from Sigma (St. Louis, Mo.). Cobalt sulfate heptahydrate (CoSO₄.7H₂O) was purchased from Alfa Aesar (Ward Hill, Mass.). Anodisc 25 alumina membranes (25 mm diameter, 200 nm pore size and 60 μm thickness) were received from Whatman (Maidstone, UK). Cyclic olefin copolymer (COC) sheets, 1.1 mm thickness, were obtained from Knightsbridge Plastic Inc., (Fremont, Calif.), while the standard black inkjet ink was received from Hewlett Packard (Palo Alto, Calif.).

Alumina membranes were used as templates for the nanowire growth. Before use, a gold layer was sputtered on one side of the membrane (where the pores are branched) to serve as the working electrode during the electrodeposition (in connection to an aluminum foil contact). Ag/AgCl (3 M KCl) and platinum wires were used as reference and counter electrodes, respectively. The sputtered membrane was placed in the bottom of a plating cell with the sputtered side contacting the aluminum foil. Silver was deposited using the amperometric mode at −0.9 V and a charge of 2 C. Following this, gold was deposited at −0.9 V using a charge of 1 C. The metal-mixture plating solution was subsequently introduced to the cell. Plating solutions composed of 40 g L⁻¹ of H₃BO₃ and differing concentrations of the metal salts [cobalt (CoSO₄.7H₂O), nickel (NiSO₄.6H₂O), and copper (CuSO₄.5H₂O)] were employed (final pH ˜3.8). The deposition from these plating solutions was carried out at a fixed potential of −1.4 V using a total charge of 15 C.

After completing the deposition, the membrane was removed from the cell and was polished to remove the sputtered gold as previously stated. The alumina membrane was then rinsed with ultrapure water and was divided into two equal pieces. One piece was placed in a 3 M NaOH solution for about 30 min to allow complete dissolution of the membrane. The nanowires were separated magnetically from the NaOH solution and were rinsed with ultrapure water until a neutral pH was obtained. The final 2.0 mL suspension contained ˜3 mg of wires (one half of the membrane). The second piece of the nanowire-containing membrane was kept intact for direct XRF analysis of the embedded nanowires. Inks containing the encoded nanowires were prepared by mixing 3.0 mg of the wires within 1.5 mL of a commercial black inkjet ink. A 30.0 μL droplet of the resulting ink was then dispensed dropwise with a pipette onto standard white printing paper (Xerox, Business 4200, 20 lb, Rochester, N.Y.) and was allowed to dry prior to the XRF readout. Bar-coded nanowires were also embedded in COC plastics by sandwiching varying amounts of the encoded nanomaterials between fused COC sheets.

XRF readouts of the nanowire composition profiles were performed on nanowires embedded in the membrane and nanowires suspended in water after dissolution of the membrane. Some spectra measurements were performed using a NITON handheld XRF analyzer, while most XRF spectra were obtained using the Kevex XRF system, with the high voltage power supply operated at 20 kV and 1.5 mA. X-rays that bombarded the nanowire samples in the Kevex system fluoresced from a Germanium secondary target with K-L₂ and K-M₃ lines at 9.90 and 11.03 keV, respectively. The XRF spectrum for each sample was acquired over 200 seconds with the Kevex XRF system and for 60 seconds with the NITON handheld unit. Acquired data, in counts per second for the NITON system and in total number of counts for the Kevex system, were recorded with reference to discrete energy levels (25 eV and 20 eV for NITON and Kevex, respectively) over the energy range of interest (0 eV to ˜20 keV). The XRF data were normalized using Microsoft Excel, this was done with respect to counts corresponding to a given K-L₂ value of one of the unchanged metals. The intensity extraction for characterizing and normalizing the remaining peaks was performed by measuring the peak height at the corresponding approximate K-L_{2,3} energies for Co, Ni, or Cu.

The one-step templated synthesis of Ni—Co—Cu alloy nanowires of different metal contents leads to a large number of characteristic XRF barcoding patterns, reflecting the composition of the corresponding nanowires. Such ability to tune the XRF peak intensities by controlling the composition of the alloy nanowires, through the composition of the plating solution.

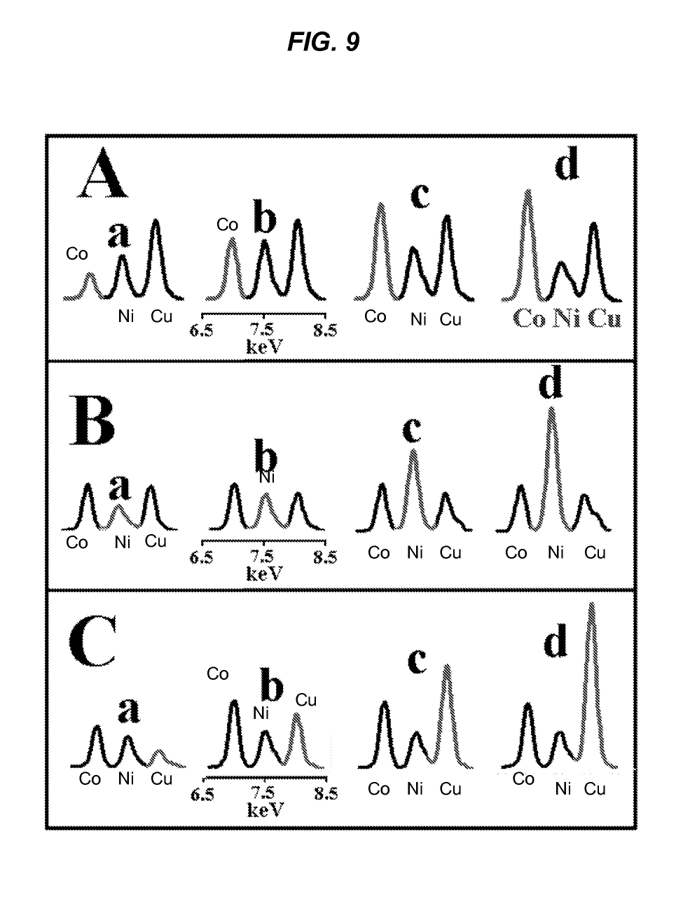

FIG. 9 displays XRF readouts of ternary wires with different composition patterns, obtained by changing the content of one metal [Co (A), Ni (B) and Cu (C); red peak], while keeping the level of the other metals constant. The measurement in A was obtained by changing the Co concentration (a-d): 10 g L⁻¹, 20 g L⁻¹, 30 g L⁻¹, and 40 g L⁻¹, respectively, with Ni and Cu at 50 g L⁻¹ and 10 g L⁻¹, respectively. The measurement in B was obtained by changing the Ni concentration (a-d): 40 g L⁻¹, 60 g L⁻¹, 90 g L⁻¹, and 120 g L⁻¹, respectively, with Co and Cu at 30 g L⁻¹ and 10 g L⁻¹, respectively. The measurement in C was obtained by changing the Cu concentration (a-d): 5 g L⁻¹, 10 g L⁻¹, 15 g L⁻¹ and 20 g L⁻¹, respectively, with Co and Ni at 30 g and 50 g L⁻¹, respectively. All metal concentrations are metal presented in aqueous solution. All alloy nanowires were electrodeposited at a potential of −1.4 V using a total charge of 15 C. The XRF spectra were obtained with the nanowires embedded in the membrane template and using a laboratory Kevex XRF system.

The alloy nanowires yield a distinct multi-peak spectra, reflecting mostly the emission of K-L_{2,3} photons and the relatively minor contributions of K-M₃ photons from Co and Ni. The approximate peak energies for the K-L_{2,3} lines are 6.9 keV for Co, 7.5 keV for Ni, and 8.0 keV for Cu, and the K-M₃ lines are 7.7 keV for Co, 8.3 keV for Ni, and 8.9 keV for Cu. The influence of the Co and Ni K-M₃ lines can be seen as tiny growing shoulders on the Ni and Cu peaks with increasing Co and Ni concentrations, respectively (e.g., the influence of the Ni K-M₃ line on the Cu peak is visible in B). Such K-M₃ line adds to the information content and distinct signature of the corresponding nanowires by adding more data for the identification of all three constituent metals.

The resulting fluorescence signatures correlate well with the composition of the plating solution, with the corresponding peak intensities following the levels of the corresponding metal in the plating solution. A slight deviation from linearity of the corresponding intensity-concentration plots was observed at the lower concentration values (not shown). Linear intensity—concentration correlations were reported earlier for voltammetric signatures of alloy nanowires following their acid dissolution. The slight nonlinearity, observed at the lowest metal concentrations, is attributed to a potential composition gradient along the nanowires, associated with differences in the ion diffusion rates. Since the number of identifiable nanowires depends upon the number of distinguishable metals and the number of peak intensities, it is possible to obtain thousands of readable XRF signatures with three or four metals present at four to six loadings. In our study using three metals we found that when evaluating a sample of wires grown from a solution containing 5 g L⁻¹ Co, 5 g L⁻¹ Ni, and 5 g L⁻¹ Cu, the detection limit (calculated following the IUPAC method 14) of the wires, dried on paper, was 30 μg/cm². The uniformity of the plating process was indicated from the low relative standard deviations of 3.4, 4.8 and 6.5% obtained for the intensity of the copper, nickel and cobalt peaks, respectively, in 6 different sections of one membrane template. Also, the reproducibility of the wires was measured by comparing several samples of wires grown from the same solution. The XRF peak heights of these data (normalized as described earlier) yielded relative standard deviations ranging between 4.3 to 8.5% for the three metals. In addition, uniform length-independent alloy compositions should greatly facilitate practical applications of the new bar-coded nanowires.

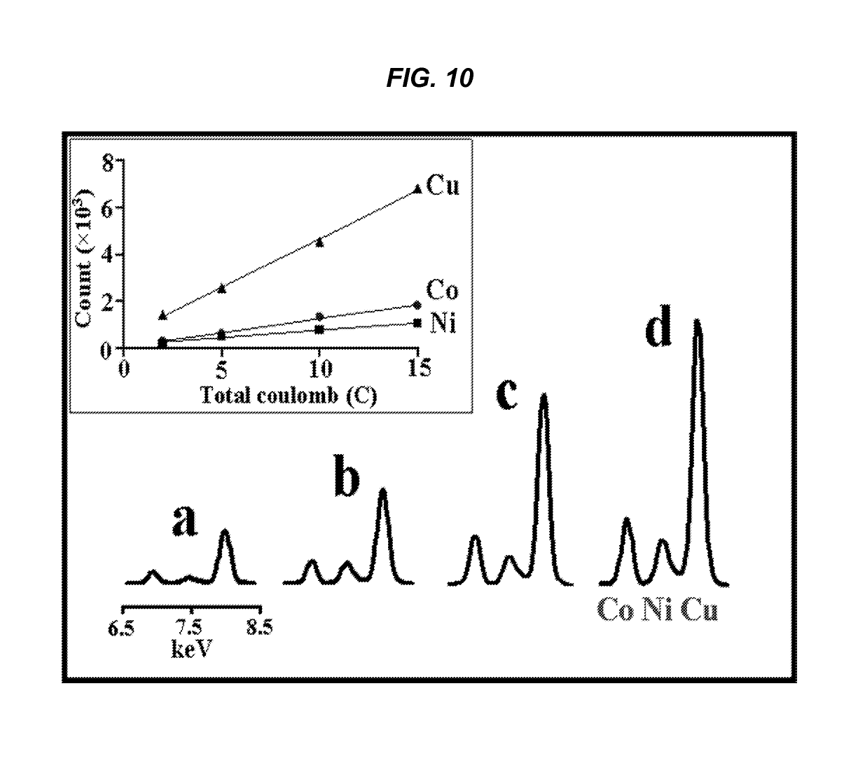

FIG. 10 shows XRF measurements for examination of the influence of the nanowire length (reflected by the deposition charge) upon the corresponding XRF peak intensities for ternary Ni—Co—Cu nanowires prepared using charges ranging from 2 C to 15 C (a-d). As expected, the signals of the three metals increase linearly with the deposition charge over the entire 2 C to 15 C charge range (see inset for the corresponding plots), indicating a uniform alloy composition along the length of the nanowires. The peak ratios in the corresponding fluorescence signatures, and hence the overall nanowire signatures, are thus independent of the charge used during the plating process (i.e., length of the resulting nanowires).

Portable XRF analyzers have found extensive field applications and could greatly facilitate numerous practical on-site applications of the encoded alloy nanowires. Accordingly, we compared the XRF signatures obtained with an easy-to-use and compact hand-held XRF unit with those recorded with a centralized large laboratory analyzer.

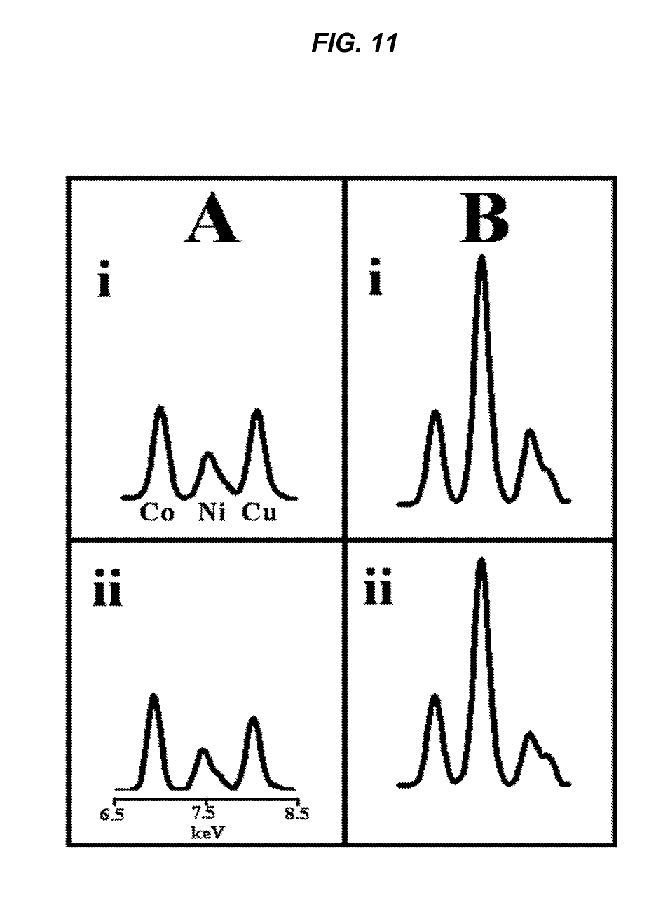

FIG. 11 shows a comparison of the alloy-nanowire XRF signatures obtained in various experiments. FIG. 11(A) indicates that both the stationary and portable systems yield similar XRF profiles, and that the identification accuracy is not compromised by the use of the hand-held analyzer. The XRF readout of the alloy nanowires can be accomplished while the wires are embedded in the membrane or after dissolving the membrane. FIG. 11(B) compares XRF signatures of ternary alloy nanowires (prepared from a 30 g L⁻¹, 120 g L⁻¹, and 10 g Co/Ni/Cu solution), as obtained before (i) and after (ii) dissolving the membrane template. Both cases yielded similar XRF signatures, with similar peak energies, intensities and peak ratios, indicating that the corresponding barcodes are not affected by the membrane dissolution. Notice again the distinct Ni K-M₃ shoulder peak, on the copper signal (B), and also the less distinct Co K-M₃ shoulder peak on the Ni response (A(ii)) that provide additional identification capability. The nanowires analyzed in the membrane represent a highly concentrated 2 dimensional array of nanowires (˜1×10⁹ nanowires/cm²) and in suspension a dilute 3 dimensional scattering of nanowires. This figure shows that a relatively small sample of nanowires can produce the same normalized XRF response as a highly concentrated sample.

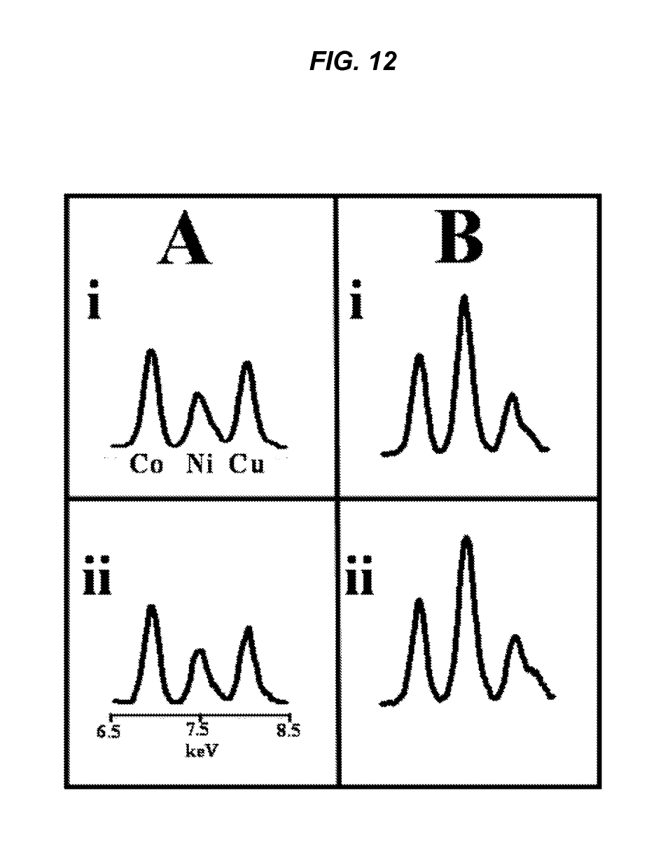

To demonstrate potential tracking and authenticity (counterfeit) applications, the barcoded nanowires were embedded within host materials relevant to product packaging. FIG. 12 illustrates the ability to read XRF signatures of alloy nanowires incorporated in a printable ink (A) or within fused plastic (COC) plates (B). Well-defined XRF signals are observed for both the ink- and plastic-embedded nanowires (ii) even with the nanowires embedded between 1.1 mm thick plastic sheets (much thicker than standard packaging plastics). In our study the resulting fingerprints are similar enough to those of the corresponding freshly-prepared nanowires to make a positive identification (within the membrane template; i versus ii). However, the exact definition of a positive identification will be left up to those using this technology, as it would depend on their specific needs. Overall, the data of FIG. 5 clearly indicate that compositionally-encoded alloy nanowires maintain their distinct XRF signatures upon incorporation in relevant host materials (with no apparent matrix effect) and that XRF leads to a convenient non-destructive readout of such fingerprints.

The above example and XRF measurements show that XRF readout can be used an effective nondestructive readout of compositionally-encoded alloy nanowires. The template-directed alloy codeposition preparation route obviates the need for sequential deposition steps (from different metal solutions) common for the synthesis of multi-segment nanowire barcodes. Such coupling of one-step synthesis with a non-destructive readout (without prior dissolution) can be used to greatly simplify practical applications of nanomaterial tags. The ability to prepare alloy nanowires with a large variety of compositions and visualize these compositions by XRF makes these alloy nanowires promising candidates for a wide variety of tagging applications ranging from product tracking and protection, counterfeit testing and bioaffinity assays.

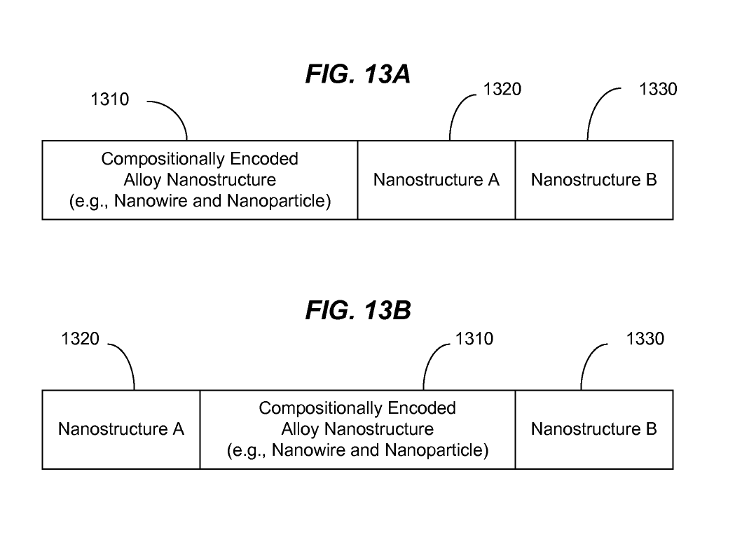

Compositionally encoded nanostructures in form of nanowires, nanoparticles or other suitable geometries based on the disclosure of this specification can be attached to other structures for various applications. FIGS. 13A and 13B show two examples of multi-segment nanostructures that include one segment 1310 made of a compositionally encoded alloy nanostructure for identification or authentication and one or more segments 1320 and 1330 to provide additional functions. The encoding part of multi-segment nanostructures in FIGS. 13A and 13B is the alloy nanostructure 1310. The one or more segments 1320 and 1330 can be nanostructures to provide various functions.

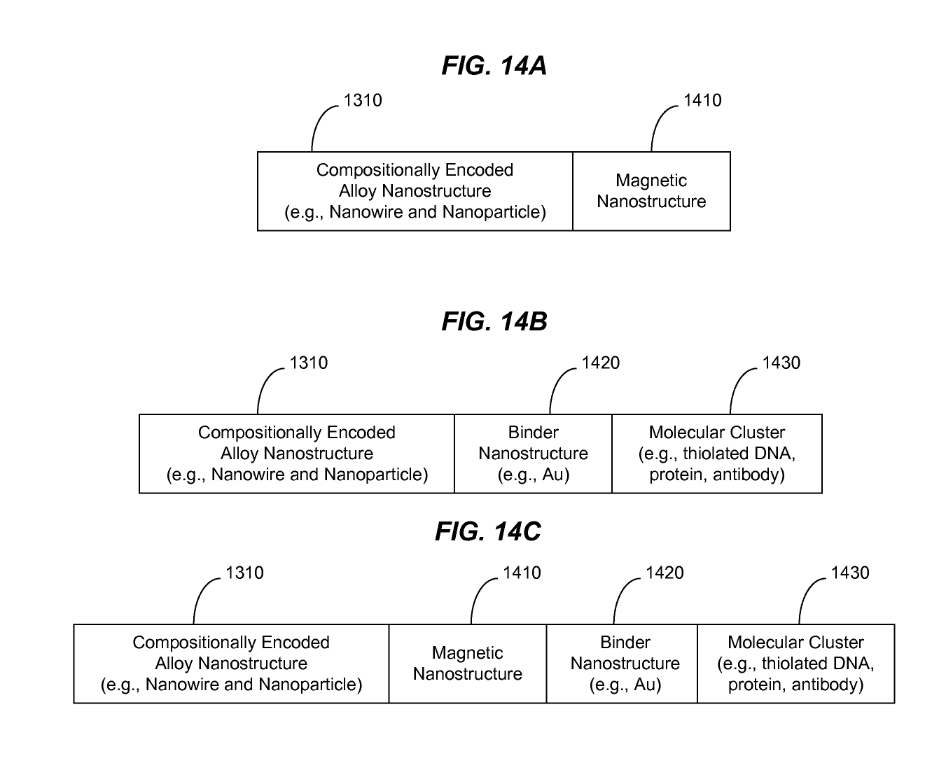

FIGS. 14A, 14B and 14C show specific examples of multi-segment nanostructures based on the designs in FIGS. 13A and 13B. FIG. 14A shows that a compositionally encoded alloy nanostructure 1310 is attached to a magnetic nanostructure 1410 such as an alloy of Ni, Co and Cu to allow for magnetic separation of the multi-segment nanostructure. FIG. 14B shows a multi-segment nanostructure with a compositionally encoded alloy nanostructure 1310, a binder nanostructure 1420 and a molecule or molecular cluster 1430 attached to the binder nanostructure 1420. The binder nanostructure 1420 is formed between the molecule or molecular cluster 1430 and compositionally encoded alloy nanostructure 1310 as a binder to bind the structures 1310 and 1430 together. For example, one common bonder material for the binder nanostructure 1420 is gold to which a thiolated DNA, a protein, an antibody or other molecular structure can be attached. FIG. 14C shows another example of a multi-segment nanostructure that combines the segments in FIGS. 14A and 14B to provide both biochemical and magnetic functions.

The above described compositionally encoded nanostructures may also be made from composite materials of a metal and a polymer. For example, electropolymerized polymers such as polypyrrole or polyanaline can be used to form compositionally encoded nanostructure tags.

The use of the composition of a nanostructure as an identification code can be used to provide an ID tag that has identically-made alloy nanostructures of an alloy of two or more selected metal elements as described the examples above. Alternatively, an ID tag may include a combination of different nanostructures with different compositions. This alternative tag design can provide an average barcode using tags made up of a single metal only, or by combining different ratios of tags that include at least two material types. Using Silver (Ag) and gold (Au) as an example, an average composition of 50% silver/50% gold could be made from three types of tags: (1) barcode tags with a 50/50 Ag—Au alloy composition, (2) a 50/50 mixture of silver single-metal tags and gold single-metal tags, and (3) a mixture of Au—Ag alloy tags with different compositions. In a more specific example, two different types of tags, tags made of an alloy of 10% Au/90% Ag and tags made of an alloy of 90% Au/10% Ag, may be mixed with an equal amount of each of the two types to generate a 50% average mixture composition as the identification code. Such mixing may be used to increase the encoding capability of such compositionally encoded tags. In one implementation, a small number of tags of different compositions can be generated and then mixed together to achieve a range of different compositions for identification codes that expand the number of codes that are based the compositions.

While this specification contains many specifics, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Unless specifically noted, it is intended that the words and phrases in the specification and the claims be given the ordinary and accustomed meaning to those of ordinary skill in the applicable arts. If any other special meaning is intended for any word or phrase, the specification will clearly state and define the special meaning. In particular, most words have a generic meaning. If it is intended to limit or otherwise narrow the generic meaning, specific descriptive adjectives will be used to do so. Absent the use of special adjectives, it is intended that the terms in this specification and claims be given their broadest possible, generic meaning. Likewise, the use of the words “function” or “means” in the “detailed description” section is not intended to indicate a desire to invoke the special provisions of 35 U.S.C. 112, Paragraph 6, to define the invention. To the contrary, if it is intended to invoke the provisions of 35 U.S.C. 112, Paragraph 6, to define the inventions, the claims will specifically recite the phrases “means for” or “step for” and a function, without also reciting in such phrases any structure, material or act in support of the function. Even when the claims recite a “means for” or “step for” performing a function, if they also recite any structure, material or acts in support of that means or step, then the intention is not to provoke the provisions of 35 U.S.C. 112, Paragraph 6. Moreover, even if the provisions of 35 U.S.C. 112, Paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

Only a few implementations are disclosed. However, it is understood that variations and enhancements may be made.

What is claimed is:

1. A method for providing a nanostructure identification tag, comprising:
stimulating an identification tag comprising a plurality of alloy nanostructures to produce a signal, each of the alloy nanostructures being made of an alloy of two or more different metal elements with predetermined relative concentrations;
measuring the signal from the alloy nanostructures to extract information on the predetermined relative concentrations of the two or more different metal elements in the alloy; and
using a combination of (1) the predetermined relative concentrations of the two or more metal elements in the alloy, and (2) a number of the two or more metal elements as an identification code to identify an object associated with the identification tag.

2. The method as in claim 1, comprising:
performing an electrochemical measurement on the plurality of alloy nanostructures of the identification tag to obtain the signal.

3. The method as in claim 2, wherein:
the electrochemical measurement comprises:
dissolving the plurality of alloy nanostructures of the identification tag in a solvent solution to form an electrolyte solution;
performing a voltammetric measurement on the electrolyte solution to measure a current or potential signal from the electrolyte solution under an applied voltage to obtain the signal; and
processing the signal to obtain ratios of concentrations of the two or more different metal elements.

4. The method as in claim 3, wherein:
the voltammetric measurement is a square-wave voltammetry measurement.

5. The method as in claim 3, wherein:
the voltammetric measurement is a pulse voltammetry measurement.

6. The method as in claim 3, wherein:
the voltammetric measurement is a linear sweep voltammetry measurement.

7. The method as in claim 2, wherein:
the two or more different metal elements are selected to have distinguishable electrochemical signatures for the electrochemical measurement.

8. The method as in claim 1, comprising:
performing a solid-state chronopotentiometric measurement on the plurality of alloy nanostructures of the identification tag to obtain the information on the predetermined relative concentrations of the two or more different metal elements in the alloy.

9. The method as in claim 1, comprising:
performing an Energy Dispersive X-Ray measurement on the plurality of alloy nanostructures of the identification tag to obtain the information on the predetermined relative concentrations of the two or more different metal elements in the alloy.

10. The method as in claim 1, comprising:
performing an Electron Backscatter Diffraction measurement on the plurality of alloy nanostructures of the identification tag to obtain the information on the predetermined relative concentrations of the two or more different metal elements in the alloy.

11. The method as in claim 1, comprising:
performing a Raman Spectroscopy measurement on the plurality of alloy nanostructures of the identification tag to obtain the information on the predetermined relative concentrations of the two or more different metal elements in the alloy.

12. The method as in claim 1, comprising:
performing an Inductively Coupled Plasma Mass Spectrometry measurement on the plurality of alloy nanostructures of the identification tag to obtain the information on the predetermined relative concentrations of the two or more different metal elements in the alloy.

13. The method as in claim 1, comprising:
performing a direct X-ray fluorescence measurement on the plurality of alloy nanostructures of the identification tag to obtain the information on the predetermined relative concentrations of the two or more different metal elements in the alloy.

14. The method as in claim 13, wherein:
the two or more different metal elements are selected to allow the alloy to produce distinguishable X-ray fluorescence signatures under illumination of an X-ray.

15. The method as in claim 1, comprising:
performing an optical measurement on the plurality of alloy nanostructures of the identification tag to obtain the information on the predetermined relative concentrations of the two or more different metal elements in the alloy.

16. The method as in claim 1, wherein:
the plurality of alloy nanostructures are formed by using a single deposition step to deposit the two or more different metal elements on a template to grow the alloy nanostructures.

17. The method as in claim 16, wherein:
the single deposition step is an electroplating step to electroplate the two or more different metal elements on the template to grow the alloy nanostructures in a plating solution containing a mixture of the two or more metal elements, and
the concentrations of the two or more different metal elements in the plating solution are controlled to generate the predetermined relative concentrations of the two or more different metal elements in the alloy as part of the identification code.

18. The method as in claim 1, wherein:
one of the two or more different metal elements is one of Bi, Sb, Pb, Sn, Tl, In, Ga, Cd, Zn, Au, Ag, Cu, Ni, Co, Te and Se.

19. The method as in claim 1, comprising:
using a hand-held analyzer to measure the signal from the alloy nanostructures to extract information on the predetermined relative concentrations of the two or more different metal elements in the alloy.

20. A method for synthesizing a nanostructure identification tag, comprising:
performing a single deposition step to deposit two or more different metal elements on a template to grow alloy nanostructure of an alloy of the two or more different metal elements; and
using a plurality of the alloy nanostructures removed from the template to form a nanostructure identification tag for identification based on the relative concentrations of the two or more different metal elements in the alloy.

21. The method as in claim 20, comprising:
controlling either one or both of
(1) relative concentrations of the two or more different metal elements the deposition, and
(2) a number of the two or more different metal elements
to generate a unique identification code for the nanostructure identification tag.

22. The method as in claim 20, comprising:
selecting the two or more different metal elements to enable the alloy nanostructures to produce distinguishable signature signals representing the two or more different metal elements, respectively.

23. The method as in claim 22, wherein:
the two or more different metal elements are selected to enable the alloy nanowires to produce distinguishable electrochemical signature signals representing the two or more different metal elements, respectively.

24. The method as in claim 22, wherein:
the two or more different metal elements are selected to enable the alloy nanowires to produce distinguishable X-ray fluorescence signature signals representing the two or more different metal elements, respectively.

25. The method as in claim 22, wherein:
the two or more different metal elements are selected to enable the alloy nanowires to produce distinguishable solid-state chronopotentiometric signature signals representing the two or more different metal elements, respectively.

26. The method as in claim 20, wherein:
the single deposition step is an electroplating process by using a plating solution comprising a mixture of two or more different metal elements to electroplate the two or more different metal elements on a membrane having pores as the template to grow the alloy nanostructures in the pores; and
separating the alloy nanostructures from the membrane.

27. The method as in claim 26, comprising:
prior to electroplating the two or more different metal elements,
forming a metal layer on a first side of the membrane to seal the pores while keeping a second side of the membrane free of the metal layer and openings of the pores on the second side open; and
using the metal layer on the first side of the membrane as a working electrode in the single electroplating step for growing the alloy nanostructures.

28. The method as in claim 27, comprising:
controlling a duration of the single electroplating step to control the lengths of the alloy nanostructures formed in the pores.

29. The method as in claim 20, wherein:
the deposition process is a multi-component vapor deposition process.

30. An article comprising an identification tag which comprises a plurality of alloy nanostructures of an alloy of two or more different metal elements, wherein a combination of (1) a number of the two or more different metal elements and (2) relative concentrations of the two or more different metal elements constitutes a unique identification code for the identification tag.

31. The article as in claim 30, wherein:
one of the two or more different metal elements is one of Bi, Sb, Pb, Sn, Tl, In, Ga, Cd, Zn, Au, Ag, Cu, Ni, Co, Te and Se.

32. The article as in claim 30, wherein:
the identification tag comprises a plastic material in which the alloy nanostructures are embedded.

33. The article as in claim 30, wherein:
the identification tag comprises a polymer material in which the alloy nanostructures are embedded.

34. The article as in claim 30, wherein:
the identification tag comprises an ink in which the alloy nanostructures are embedded.

35. The article as in claim 30, wherein:
the alloy is formed from a single electroplating process using a plating solution comprising a mixture of the two or more different metal elements.

36. The article as in claim 30, wherein:
each alloy nanostructure is attached to a binder structure that binds one or more molecules to the alloy nanostructure.

37. The article as in claim 30, wherein:
each alloy nanostructure is attached to a gold nanostructure that binds a DNA or protein.

38. The article as in claim 30, wherein:
each alloy nanostructure is a nanowire.

39. The article as in claim 30, wherein:
each alloy nanostructure is a nanoparticle.
